(19) United States
(12) Patent Application Publication
(10) Pub. No.: US 2004/0096199 A1
(43) Pub. Date: May 20, 2004

(54) Editing system and software for automatically creating interactive media

(76) Inventors: Charles C.L. Chou, Kailua, HI (US); Andrew Jeffrey Crilly, Cupertino, CA (US); Fred Shiu Leung Chan, Los Altos, CA (US)

Correspondence Address: CARPENTER & KULAS, LLP, 1900 EMBARCADERO ROAD, SUITE 109, PALO ALTO, CA, 94303, US

(21) Appl. No.: 10/295,372

(22) Filed: Nov. 14, 2002

(51) Int. Cl. H04N 5/781; G11B 27/00

(52) U.S. Cl. 386/125; 386/126

(57) ABSTRACT

A system and method for creating interactive media such as DVDs. Raw content is edited into chapters, together with menus that allow quick access to the chapters. A finished multimedia title in various formats may be created. The finished title is pre-mastered and may be duplicated locally or may be sent out for mass production.

### BACKGROUND OF THE INVENTION

1. Field of the Invention

The present invention relates generally to editing systems and software, and more specifically to an editing tool for making master copies of DVDs and other media that can later be reproduced. The present invention is especially useful for mastering interactive multi-media content.

2. Related Art

The design and production of interactive multi-media materials is a labor intensive and therefore expensive process. In general, each application for making multi-media materials is custom designed to meet specific requirements of the product.

One way to make interactive multi-media titles such as DVDs involves the use of sophisticated editing machinery and techniques generally used to master full length feature films on DVD. While the flexibility such systems afford allows for the inclusion of custom features, the time, effort, financial investment, and most of all the skill level necessary to use this type of set-up is prohibitive for all but large production houses and the like. To create a feature length film on DVD requires a team of specialized people each skilled in a small subset of the process, such as graphic artists and designers, video editors, production specialists and production managers etc . . . . Likewise, creating any other content on DVD using the same equipment has the same requirements.

A wide variety of multimedia applications and environments can be enhanced with interactive content, and thus the demand for DVDs and other interactive formats is rapidly growing. Many more traditional environments, such as the field of education, for instance, greatly benefit from dynamic interactive presentations that allow choice during presentation and tailor the experience to the audience. In these environments, the resources available for making an interactive title are substantially less than those for making a full-length feature movie or television series DVD. Additionally, some of these other environments may have other unique needs that are not currently met with the prior authoring systems.

Other ways to make interactive multi-media titles involve the usage of more convenient software packages on personal computers. These computer packages generally offer less flexibility but are easier to use and streamline the process. However, each of these prior computer packages has its own limitations and drawbacks.

One approach taken in prior packages is the use of templates. These templates provide a convenient yet relatively rigid starting point for the process, tend to be simplistic, and provide only a small number of features that can be routinely incorporated.

This, and other prior approaches and solutions are limited in terms of content, format, layout and ease of use etc . . . .

### SUMMARY OF THE INVENTION

The present invention greatly simplifies the creation of interactive multimedia titles in various formats. Presently, the system can create titles in DVD-Video, DVD-ROM, and ViDVD formats. It is foreseen that the system may also be used to create titles for other interactive formats as they become available.

The system and method of the present invention can be implemented on and may comprise one or more personal computers. Many tasks may be completed in parallel by various personnel on networked computers in order to minimize the time necessary to create a finished title. In one embodiment of the invention, the system and method may be thought of as an assembly line for making finished multimedia titles, wherein various components or assemblies are made rapidly and contemporaneously and then assembled together. Alternatively, a single personal computer may be used to minimize costs and to provide a more portable solution.

Various interfaces are provided for creating menus, editing audio and video input, building previews and the final title, and for pre-mastering the final title.

One aspect of the invention is taking raw content that is, for example, on a video tape, and separating the audio and video files into two separate streams. The two separate streams are synchronized and played back by the system for editing. The two synchronized streams may also be subdivided by the editor into shorter segments or chapters that can be quickly accessed with menu buttons.

Another aspect of the invention is that the menu buttons and the underlying functionality of the buttons are automatically created with the system of the present invention. This means that when a button is created, a button image is created together with the function (software code) that transports the viewer to the proper location when the button is selected. For example, if a menu button entitled “Chapter 4” is created, when an author creates the button image the system automatically creates the underlying function and corresponding code that will transport the user to the audio and video content corresponding to “Chapter 4.”

### BRIEF DESCRIPTION OF THE FIGURES

For a complete understanding of the present invention and for further features and advantages, reference is now made to the following description taken in conjunction with the accompanying drawings.

FIG. 1 is a block diagram showing system 100, an embodiment of the present invention.

FIG. 2 is a flowchart illustrating the creation of a multimedia title using an embodiment of the present invention.

FIGS. 3A-3M are interface screens of the editing subsystem.

FIGS. 4A-4Q are interface screens of the menu creation subsystem.

FIGS. 5A-5C are interface screens of the build subsystem.

FIGS. 6A-6C are interface screens of the pre-master subsystem.

FIG. 7 is a block diagram showing the relationship of the chapterized content on the disk and its other internal resources to the content available externally, including the web.

### DETAILED DESCRIPTION

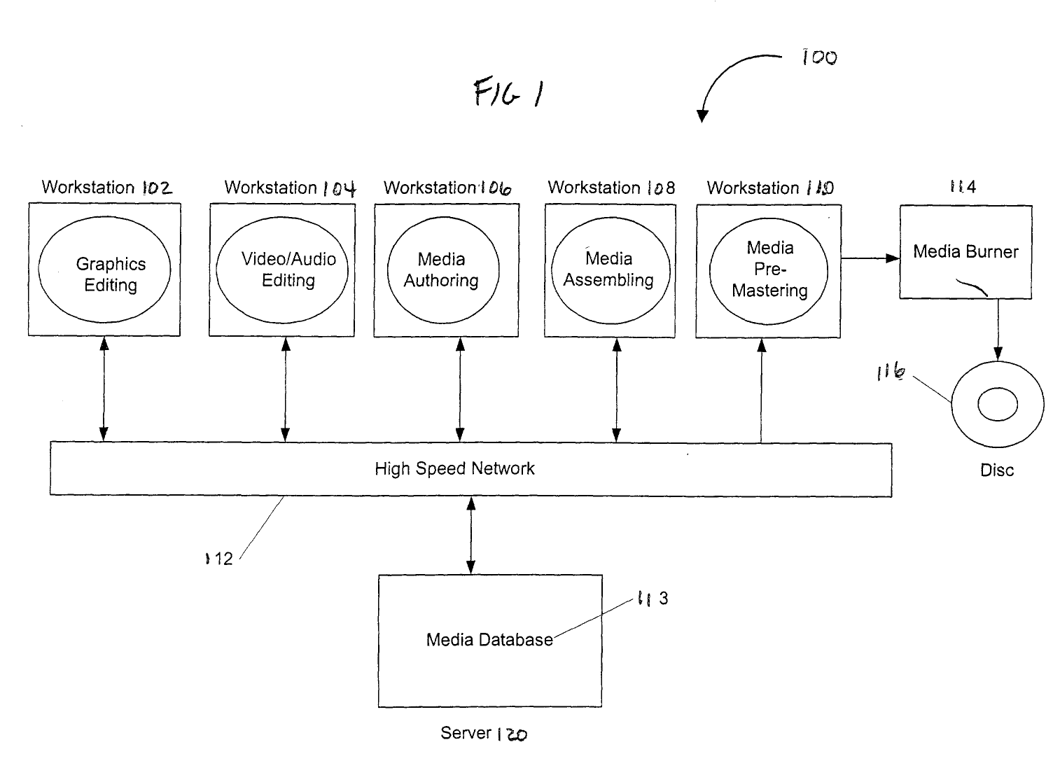

The preferred embodiments of the present invention and their advantages are best understood by referring to FIGS. 1 through 7 of the drawings, which will now be described in detail. Like numerals are used for the like and corresponding parts of various drawings.

The present invention significantly enhances productivity over manual authoring systems and methods that have been developed to date. The system and its methodology are a departure from prior methods of authoring content. Some old methods relied on serial assembly of various tasks, i.e. before moving on to one task, the task before it had to be completed. In sharp contrast, in the present invention, the tasks may be completed in parallel. All the tasks may be performed on either one computer, or preferably on more than one computer to maximize the parallel development capability of the system. To minimize the time to produce a title, many people can work on the project at different stations simultaneously, or in order to minimize the capital costs of the system, the entire system may comprise one computer, and the work may be performed on the single computer. The one time coding and the automated “assembly line” process minimize or eliminate waiting time by authors, and reduce the amount of manpower required for a given project.

As shown in FIG. 1, in the case where time is of the essence, and the parallel assembly line mode of operation is taken advantage of, each workstation 102-110 may automatically and independently feed its' output to media database 113 on server 120. Media database 113 may also be located on any workstation connected to network 112. The workstations may be any personal computer. Network 112 may be any type of high-speed network such as a local area or wide area network and may also comprise the Internet and a connection to the Internet. From media database 113, which serves as a repository of assets, the media burner 114 receives the authored title before mastering into a selected format, such as DVD-Video, DVD-ROM, ViDVD or other format, and then automatically creates a “quick build” version for viewing and testing purposes. This allows manual checking of the product before completing the final mastering process and set of test disks that are required for independent quality control of the whole process. The ViDVD format is an interactive DVD format that blends content on a DVD disc with content on the Internet in a variety of different ways. The Internet content may comprise web pages or other content. Additional information on the ViDVD format, ViDVD players, and discs is available from Vialta Inc., of Fremont Calif.

FIG. 2 illustrates a method of creating a DVD or other media format according to an embodiment of the invention. In step 202 an input video, which may or may not include accompanying audio, and is typically a video tape or other video file, is encoded into separate audio and video tracks or segments. The tracks or segments are typically relatively long so that they may later be subdivided. The separate audio and video tracks are saved onto the storage devices of the system 100 in step 204. The video track illustrated is D_ALL.M1V, and the audio track is D_ALL.M1A. Generally one audio and video track are created and saved onto the storage device. However, in some cases where the necessary information is not contained in one input (videotape etc . . . ), multiple inputs may be used and will result in multiple outputs (audio and video tracks).

Most multimedia players today require that the video track and audio track be multiplexed, or “muxed”, together to form a sequence of packets, each packet containing a small segment of video and one or more accompanying audio. This is so that when these packets are laid out on an optical disc in a contiguous manner, minimum read-head movement is needed during playback therefore eliminating potential seek delays. Since the output from a typical encoder yields separate video streams and audio streams, it is a time consuming and difficult step when creating a title to have to mux them together for playback purposes during authoring and then de-mux them for cutting/editing. Because system 100 of the present invention saves the audio and video tracks, chapters and the disc image to a magnetic disk, where head movement efficiency and throughput are much higher than those of optical discs it is not a problem to synchronize and playback the separate audio and video tapes. System 100 takes advantage of this and preprocesses the video to derive precise timecodes, at about ½ sec intervals. These precise timecodes are used to synchronize the video track with the audio track during playback within an editing session. Therefore, the separate tracks do not have to be multiplexed for playback and editing.

To accomplish this, the system utilizes a proprietary MPEG-2 decoder, as most commercially available decoders are designed to play already muxed “system streams” or audio and video tracks, or alternatively to play video and audio streams separately.

If for some reason, a person (“user” or “author”) who wishes to create a DVD cannot access system 100 either directly or remotely via high speed network 112, the author can work remotely. The remote user may use an embodiment of the invention comprising a single computer. The remote author's contribution can later be integrated with that of other authors to form a finished title, if so desired. In order to work remotely, the audio and video tracks may be burned onto a DVD or other media for remote chaptering in step 208.

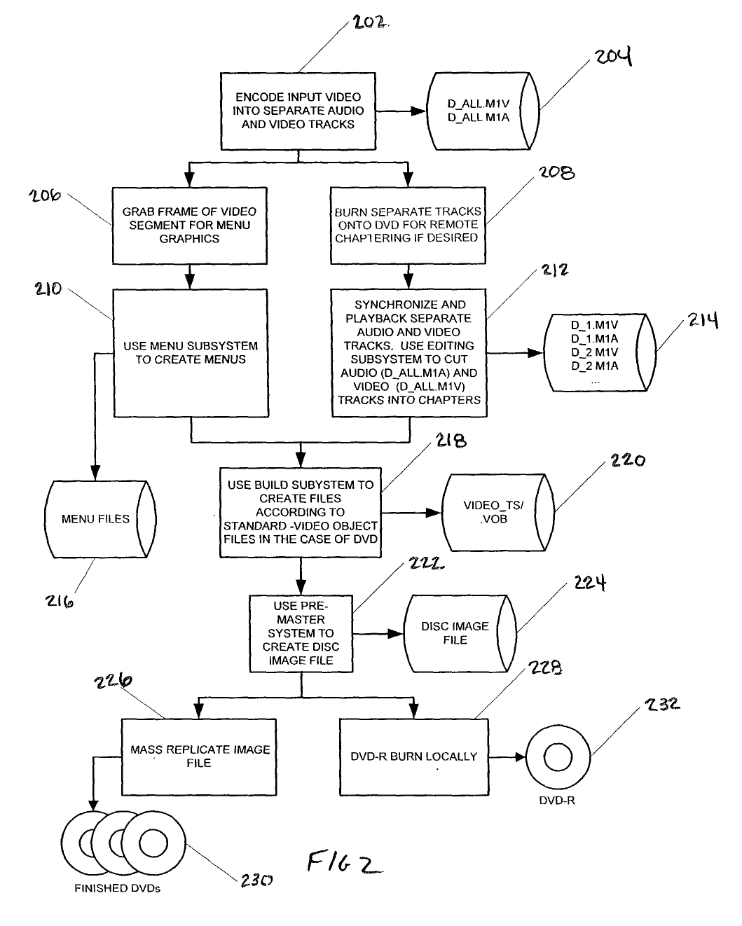

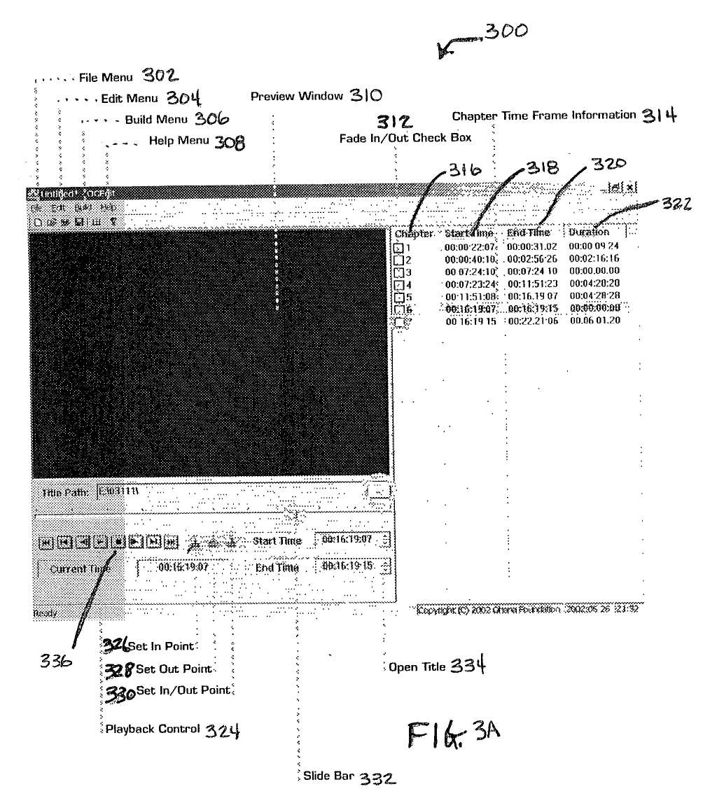

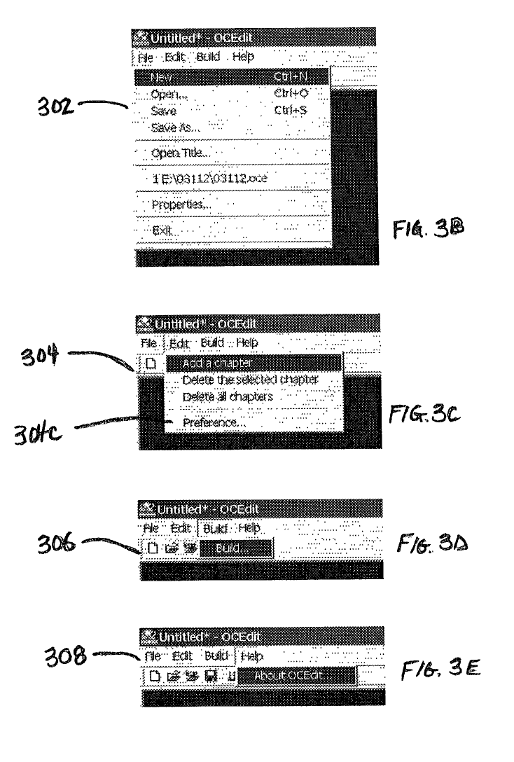

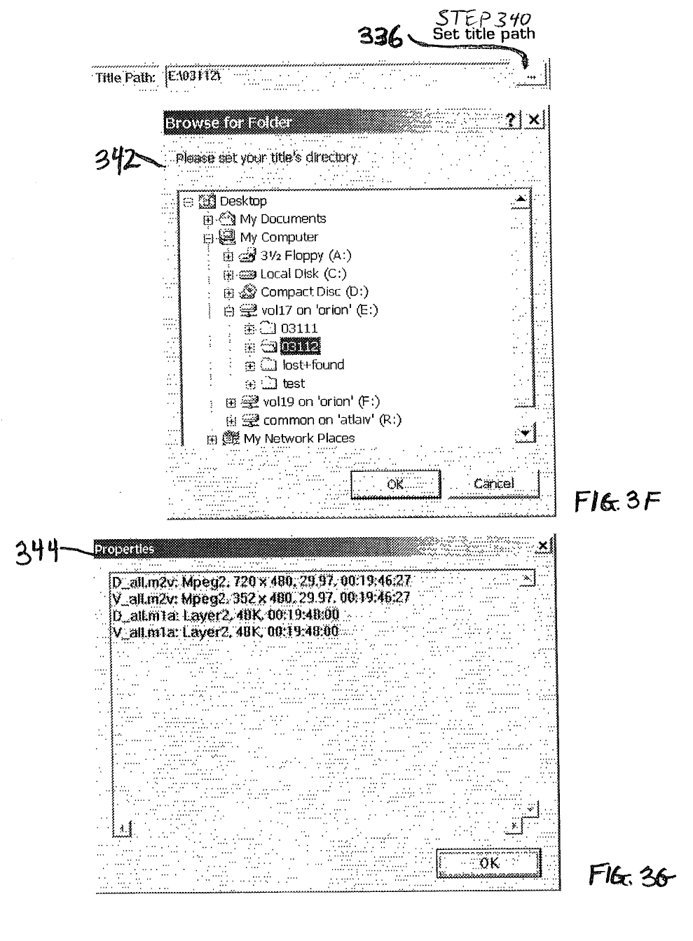

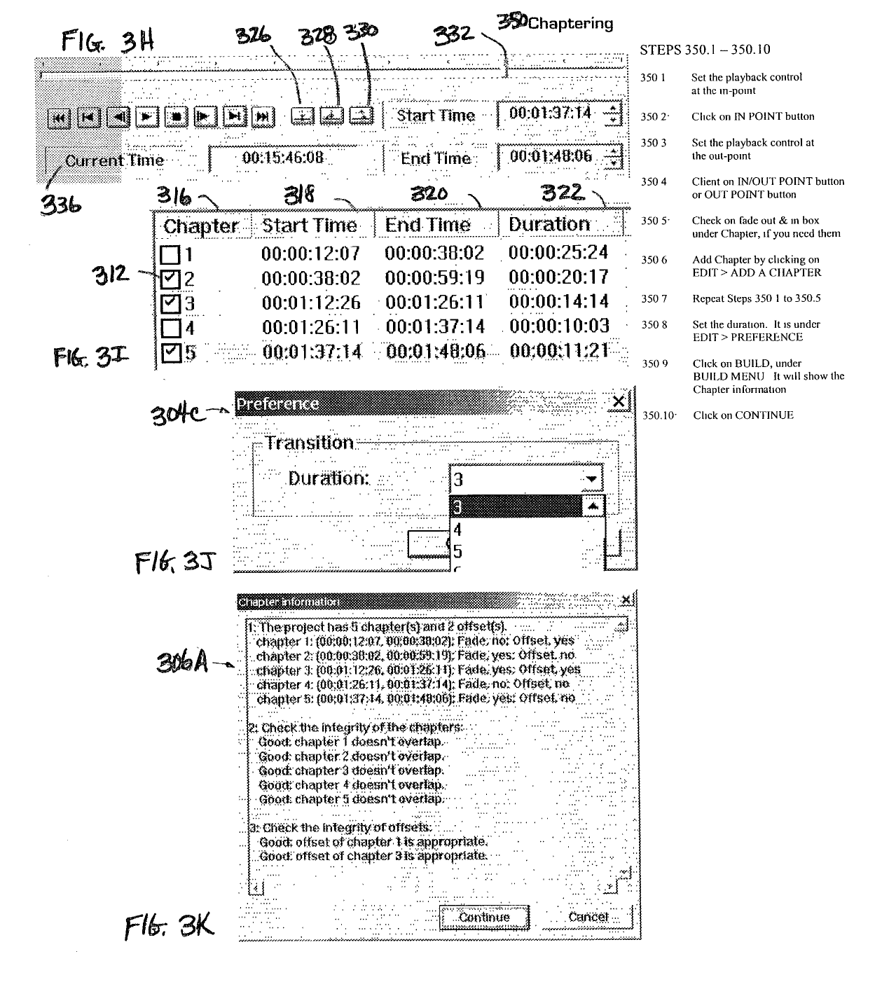

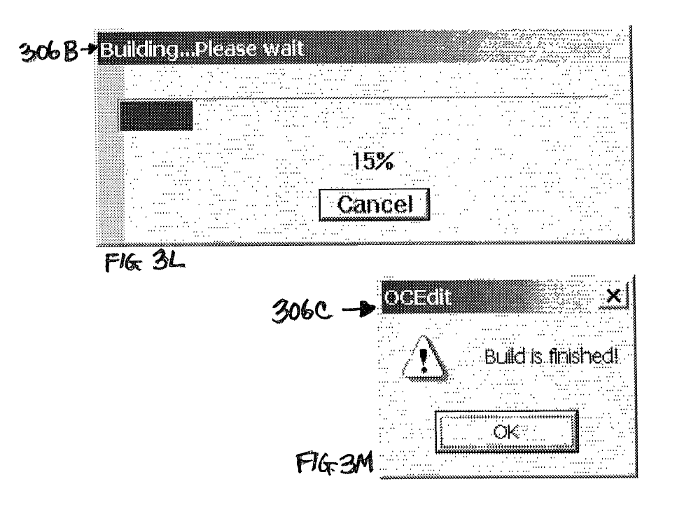

The creation of the chapters and the menus may take place in parallel in order to minimize the time necessary to create a finished title, whether it be on DVD or other format. They may also, of course, take place serially. In step 212, the system will synchronize and playback the separate tracks saved in step 204 so that an author or other user may watch the tracks and decide how he would like to subdivide the information into chapters. The author uses the editing subsystem, described later in regards to FIG. 3, to cut the audio and video tracks into chapters. This is accomplished by stopping or pausing the playback and clicking on buttons to input the chapter start and finish times and will be described later in further detail. The separate chapter video files and audio files for each chapter are saved in step 214. In this example, the files for two chapters are illustrated: chapter 1—D_{—1}.M1V and D_{—}1M1A; chapter 2—D_{—}2.M1V and D_{—}2.M1A.

The chapters may also include subtitles or other textual information. For example, subtitles may include translations of foreign languages. Multiple language subtitles may be saved with the chapters so that the user may simply select the language of choice.

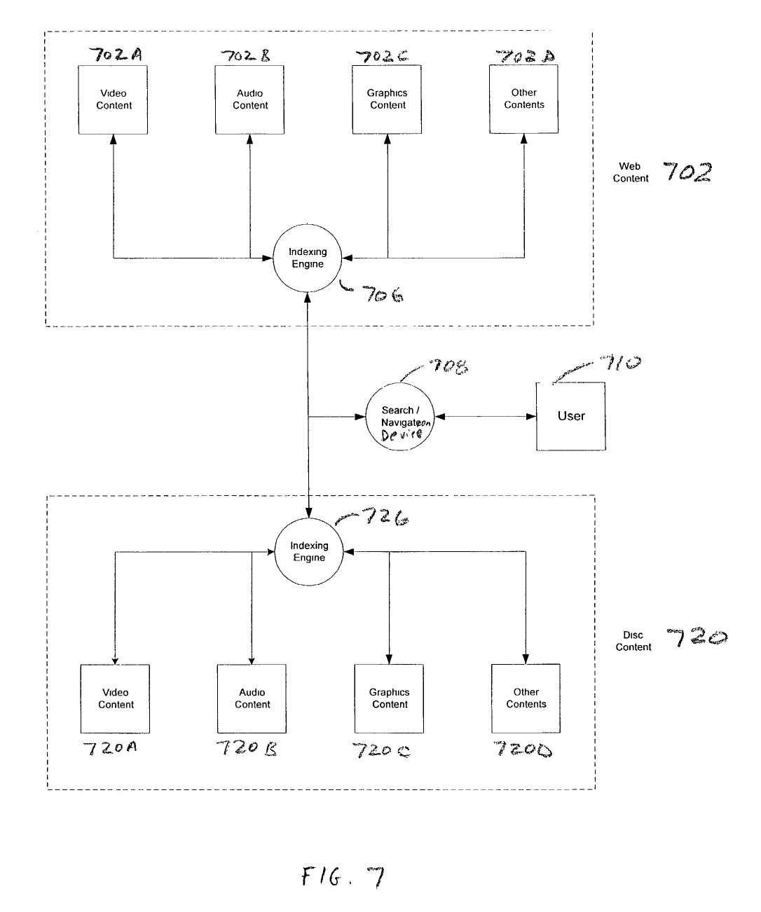

The author can also select effects, such as gradual fading in and out of picture and sound at the beginning and ending of a chapter from one of the settings options provided on the editing system 300 for that purpose. These effects will determine the replay features of the video for the chapter. At this stage the precise links that each chapter will make to a variety of other resources, such as Web based resources or other local text or image files that will provide additional reference material for the chapter, are made via the editing subsystem. Access between the web and DVD media via these links will be discussed later in reference to FIG. 7. The additional reference material may include any text that may add to the audio, such as subtitles, or translations of spoken words. There is no prescribed limitation on the number of chapters, their order, the number of linked files or whether they will ultimately reside on the DVD disk or will be called from the Web. It is immaterial, as the Editor subsystem may create buttons that access a wide variety of files, links, or addresses.

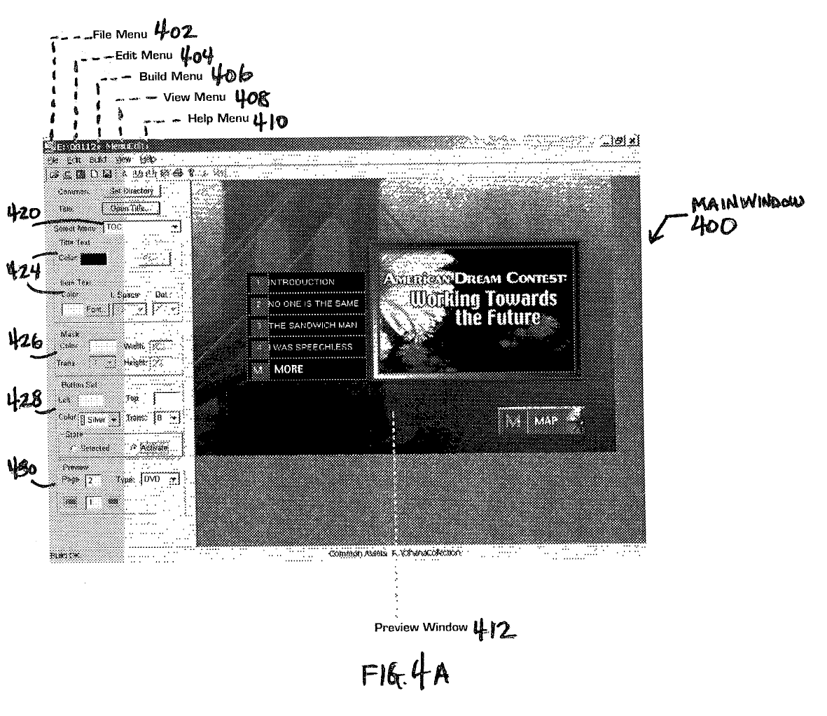

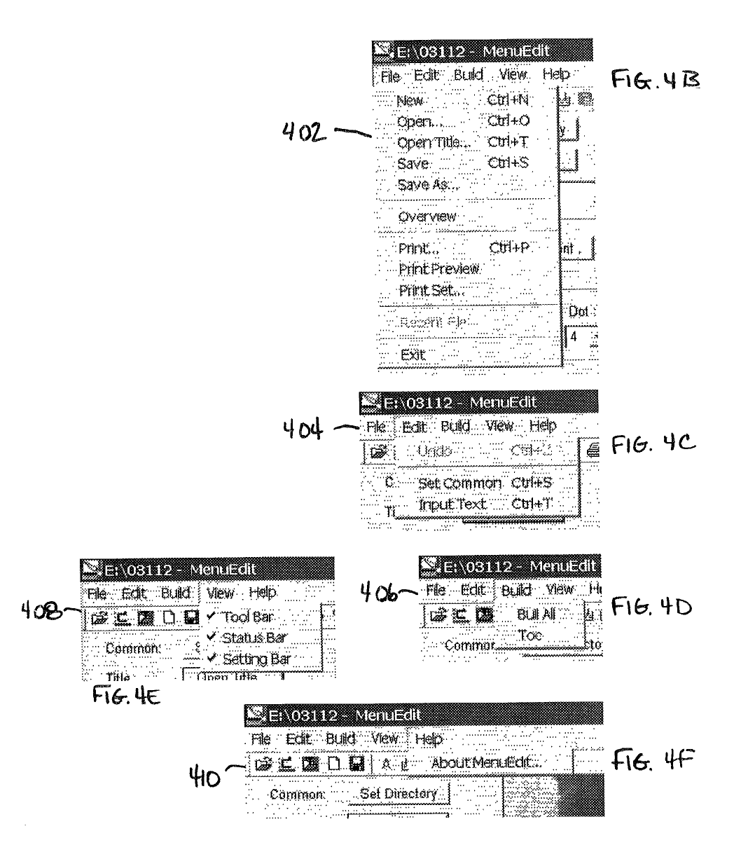

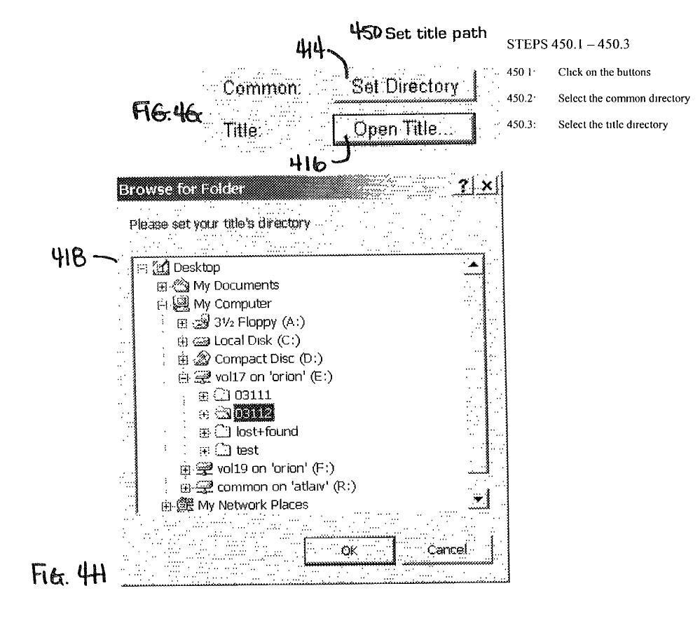

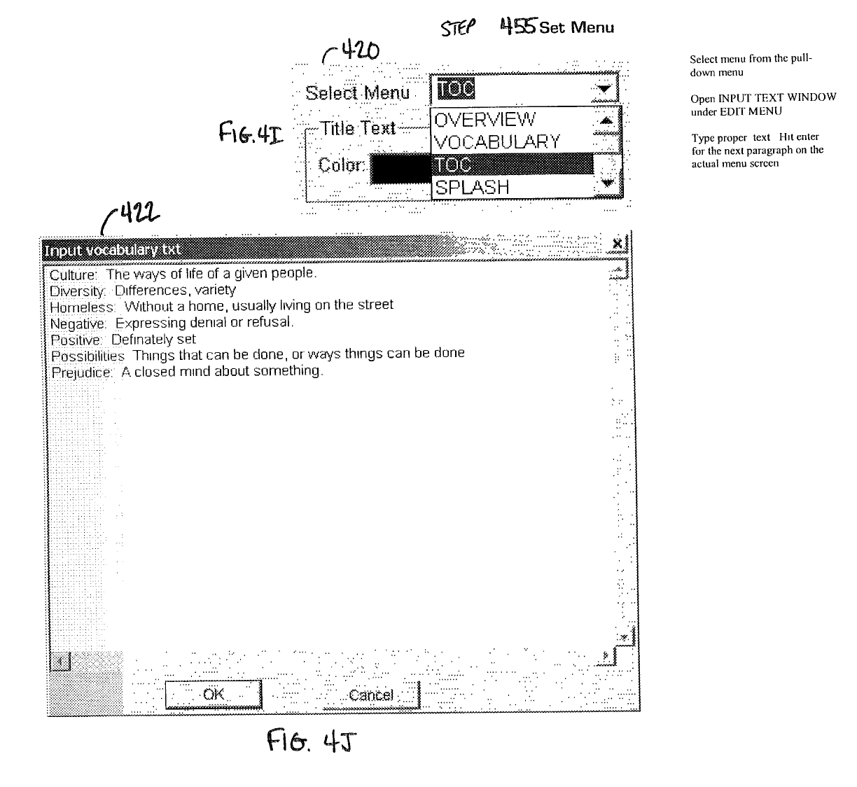

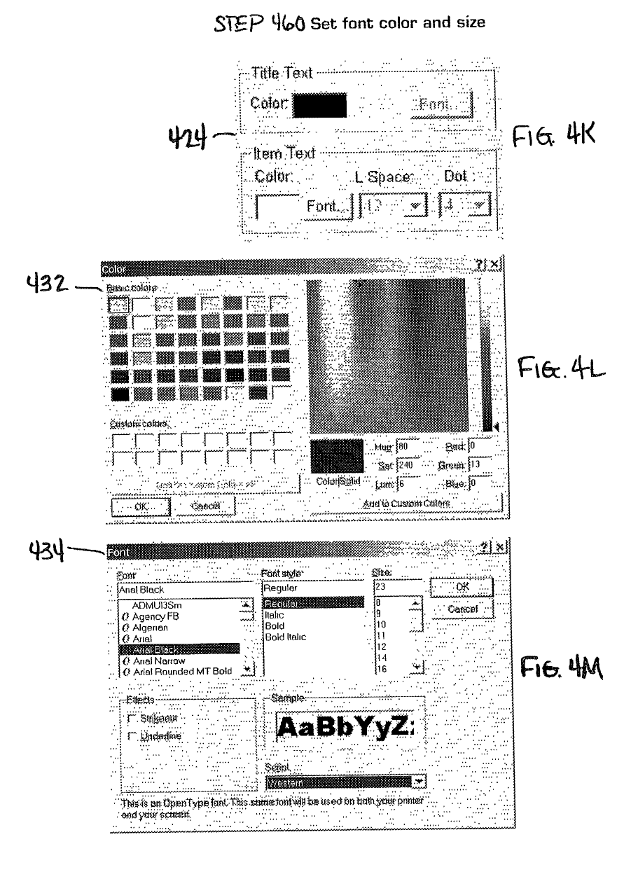

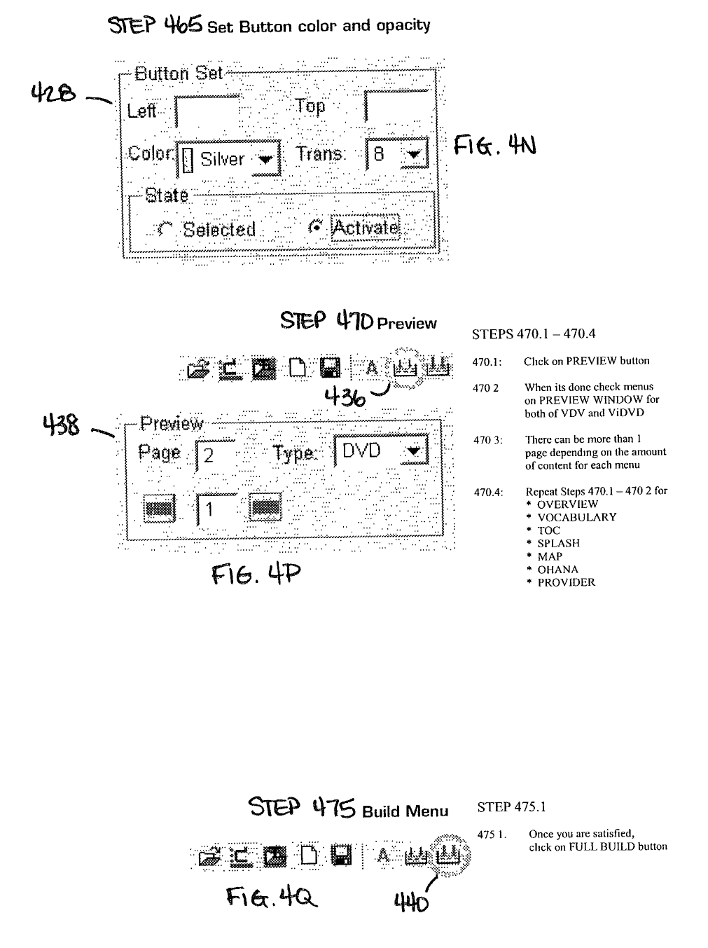

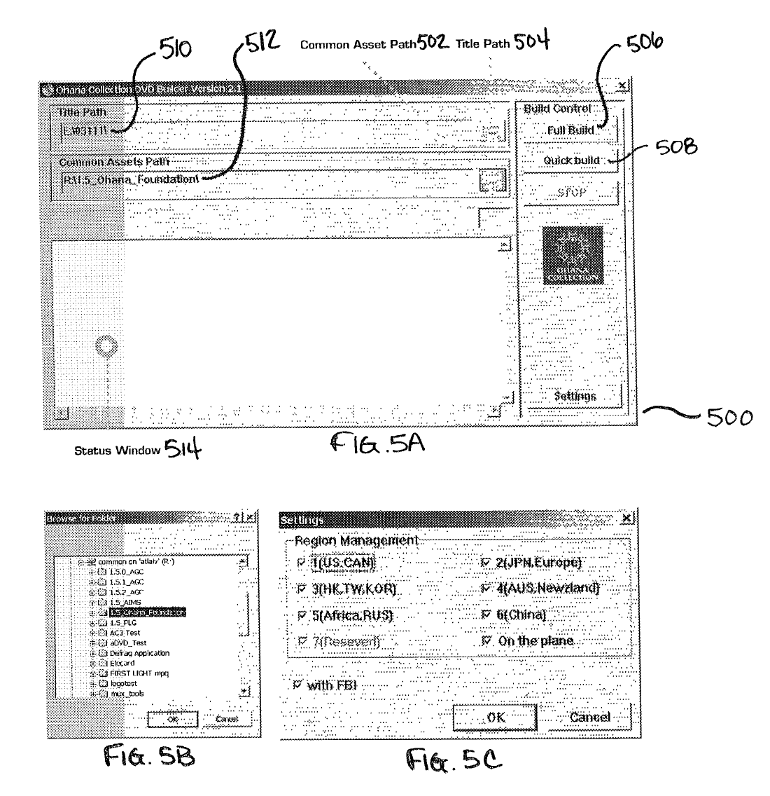

Steps 206, 210 and 216 illustrate the creation of the menus using the menu creation subsystem. In step 206, the user grabs a frame of the video track for use as a menu background. This is simply done by stopping or pausing playback of the video track and clicking on a button of the menu subsystem to select the desired menu background. Creation of the menus also involves creating the various buttons and text that a viewer uses to directly access the chapters of the title, and will be described in further detail later with regard to FIG. 4. The buttons are graphic areas that when clicked upon instigate a series of actions that access chapters. A user need simply instruct the system to create the button, and the system will automatically create the underlying functionality of the button that links directly to the assigned chapter, or other content. In step 210, based upon the user's selection, the menu subsystem creates the menus for the title, and in step 216 the menu files are saved.

Once the menus and the chapters are created, the user then accesses the build subsystem to create files according to accepted industry standards and/or proprietary formats in step 218. In the case of a DVD, video object (VOB) standard files are created. In step 220 the video object files are saved to disk. In this illustration VOB file VIDEO_TS/.VOB is saved to disk.

Next a disc image file must be created for subsequent mastering of the disc. In step 222, the disc image file is created using the pre-master subsystem. In step 224, the disc image file is saved.

The user may then decide whether he desires to have the disc image mass replicated and/or make a few copies locally with a DVD burner. In step 226, this image file is transmitted to a replication facility to create finished DVDs 230. This is not done with system 100 but is done with a dedicated mass replication system. On the other hand, the user may use system 100 to burn a DVDR 232 in step 228.

The user interface screens of the various interfaces and subsystems of the present invention will now be described in detail. The system of the present invention may be considered to have a number of subsystems that each performs different types of tasks. Some of the subsystems may be used concurrently in parallel to arrive at a finished production quality DVD or other type media. The pull down menus, and the interfaces that will be described have the familiar look, feel, and structure of the well known Microsoft Windows® interface. The functions in the pull down menus may duplicate the direct access buttons available on the various interface screens and may introduce additional less often used functions, features, and information.

FIG. 3A illustrates the main interface 300 of the editing subsystem. The interface 300 has several pull down menus in the upper left hand area of the screen: file menu 302; edit menu 304; build menu 306; and help menu 308. Clicking on each of these menus reveals a number of functions relevant to each of the menus. Preview window 310 displays video files for playback and editing. Editing details are shown on the right of the interface. This information reflects what is being generated by the controls in the bottom left of the interface.

Playback controls 336 include buttons for starting playback, forward and reverse cueing at different rates, forward and reverse segment advance, pause, and stop. Set in point button 326 is used to mark the time where a chapter will begin. Set out point button 328 is used to mark the time where a chapter will end. Set in/out point button 330 can be used to set either the in or out point depending on whether an in point or out point has already been set for a particular segment. Slide bar 332 shows the position within a chapter or clip that is presently being displayed in preview window 310. Slide bar 332 may also be moved by the user in order to skip to a different time within the clip being viewed. When activated, open title button 334 will allow the user to open a title for editing with interface 300. Chapter column 316 displays the number of chapters the user has designed. Each chapter displayed within chapter column 316 also has a fade in/out check box 312 that a user may check if the user would like a particular chapter to fade in and out. Chapter time frame information is displayed in start time column 318 and end time column 320. The Duration of the various chapters is also displayed in duration column 322.

FIGS. 3B-3F illustrate the pull down menus 302-308 seen in FIG. 3A, after a user has selected or “pulled down” each of the menus. FIG. 3B illustrates file menu 302. In file menu 302, the typical file features for opening new and current files and saving files are present.

FIG. 3C illustrates edit menu 304, where chapters can be added and deleted, and preferences set. FIG. 3D illustrates build menu 306, where the build operation may be selected. The build operation, and the other operations and functions will be discussed later, in an example of creating a finished product. FIG. 3E illustrates the help menu, where information about the system and other help functions may be found.

FIGS. 3F-3M will be used to give a general operating overview of the system, and in particular of the editing subsystem. In step 340, the title path for the input file or files is set by the user. This is done by activating title path button 336. The user can then select the file or files with browse menu 342. The properties of the selected file may also be displayed in properties window 344, shown in FIG. 3G, by selecting properties in file menu 302. After the input file or files have been selected, chapters may be made from the file(s). For each of the chapters, the user marks the in-point by setting playback control at the in-point in step 350.1. This is done with using the playback controls 336 seen in FIGS. 3A and 3H. In step 350.2, the users sets the in-point by clicking on the in-point button 326 or in/out point button 330. The user then sets the playback control at the out-point using the playback controls 336 in step 350.3. In step 350.4, the user sets the out-point by clicking on the out-point button 326 or in/out point button 330. Then, the user may select whether or not a chapter should fade in or out by checking the fade box 312. The chapters and fade boxes 312 are shown in FIG. 31. If the fading is desired, the duration of the fade time can be set in preference window 304C selected through edit menu 304, as seen in FIG. 3J. This is then repeated for as many chapters as the user would like to create. The user can view all the chapter information at any time by selecting build from build menu 306 and the window will be displayed in chapter information window 306A as seen in FIG. 3K.

If the chapter information is satisfactory, the user can build the individual chapter files. Each chapter will then have its own audio and video file, which can later be accessed through the menu structures. The chapter files are built by selecting the build command seen in build menu 306, shown in FIG. 3D. The building process is shown in windows 306B and 306C of FIGS. 3L and 3M, respectively.

The menu creation subsystem is illustrated in FIGS. 4A-4F. The main menu creation window 400 is shown in FIG. 4A. It is comprises preview window 412, and numerous other buttons and pull down menus, some of which will be described further in subsequent figures. The pull-down menus include: file menu 402; edit menu 404; build menu 406; view menu 408, and help menu 410. There are also short-cut buttons just below the pull down menus that replicate some or all of the pull down menu functions. Menu creation window 400 also includes set directory button 414, open title button 416, item text window 420, mask window 426, button set window 428, and preview window 430.

File menu 402 is shown in further detail in FIG. 4B, where general file functions for opening and saving and printing are available. Edit menu 404 is shown in FIG. 4C, where text may be input from another application, and SET Common sets the directory path where common assets are located. Common assets are graphic elements and video/audio clips that are used by all titles to retain a consistent look and feel. FIG. 4D shows build menu 406, where the build all option and the build table of contents (TOC) option is available. FIG. 4E shows the view menu 408 and its available options, and FIG. 4F shows the help menu 410.

Operation of the menu subsystem will be illustrated with regard to FIGS. 4G-4Q. In step 450, the title path is set. This is done with the set directory button 414, the open title button 416, and the browse window 418 shown in FIGS. 4G and 4H. In step 455, the menu text is set using pull down select menu 420, as shown in FIG. 41. With select menu 420, the user can select which menu to create or edit. Text is entered in text input window 422, as seen in FIG. 4J. In step 460, the font color and size is adjusted with text windows 424, 432, and 434 as seen in FIGS. 4K, 4L, and 4M, respectively.

In step 465, the button color and opacity may be set using button set window 428 shown in FIG. 4N. In step 470, the user may choose to preview the menus before build step 475. This is accomplished by pressing the preview button 436. When preview window 438 seen in FIG. 4P is visible, the preview page and type may be selected. There can be more than one page depending on the amount of content for each menu. More than one type of output may also be chosen. The types may be: DVD-Video, DVD-ROM, ViDVD, or other video formats. Steps 450-470 are then repeated for each menu screen desired. The user may select however many menus they wish. In step 475, after the user is satisfied with the preview, he or she can build the menus and the various menu output files using build shortcut button 440 seen in FIG. 4Q, or may do so through the build pull down menu 406.

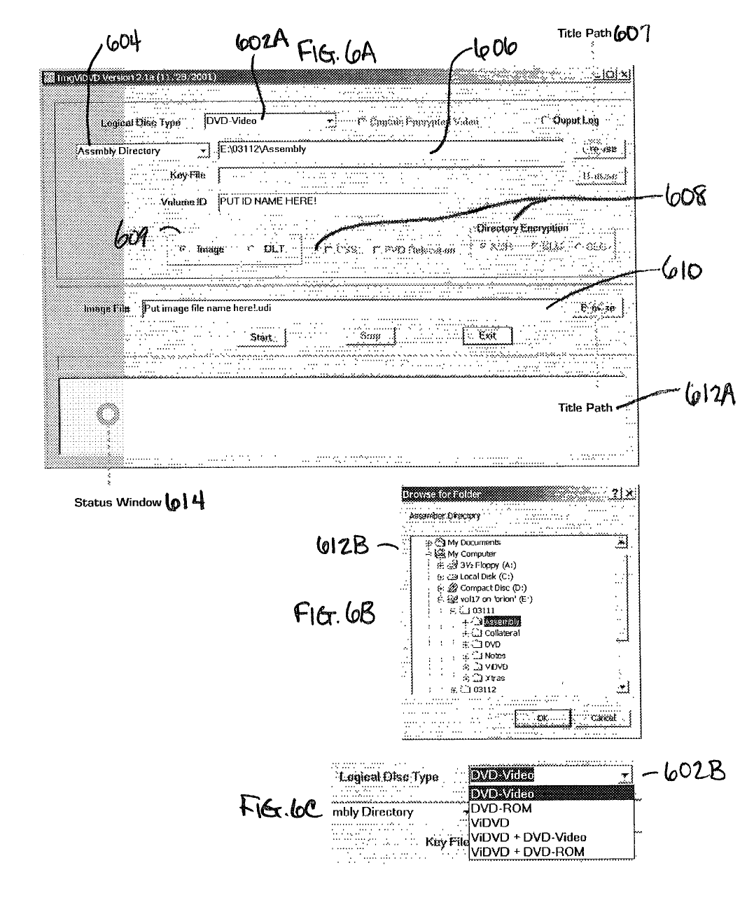

FIGS. 5A-5C illustrate the build subsystem. Some aspects of the build subsystem have been described with regard to build shortcuts in the previous subsystems. Main interface window 500 generally controls the build process, but the build process may be invoked from within the other subsystems. In box 510 and box 512 the title path and common assets path are respectively set. The user can browse for title path or common assets path by selecting the common asset path button 502 or title path button 504, respectively. Once these have been set, the user can also check and set the settings for various DVD region codes according to the DVD-Video specification and decide whether to include the familiar FBI warning regarding unauthorized duplication. The user can select a Full Build or a Quick Build with buttons 506 and 508, respectively. A Quick Build is an abbreviated version of Full Build, where only the first 30 seconds of each of the chapter video will be used to create a logically correct title with all the menus and buttons correctly linked. This is useful for providing a quick quality assurance check as it can be built usually in 1/10 the time and can be put on a low cost CD-R media. A Full Build includes the entire content of the formal title.

FIGS. 6A-6C illustrate the image or pre-mastering subsystem. Initially, the user selects the assembly directory with box 604, i.e. the user selects where the various assembly files will be saved. In box 602A, the logical disc type can be selected. When the pull down menu of box 602A is selected the choices of box 602B of FIG. 6C become available for selection of a logical disc type. The logical disc type can be DVD-Video, DVD- ROM, ViDVD, and combinations such as ViDVD+DVD-Video and ViDVD+DVD-ROM. The complete title path can be input in box 606, or if the user wishes to browse for the title path with title assembly path button 607, browsing window 612B shown in FIG. 6B will appear. The encryption type can also be selected in box 608, and the output destinations can be set in box 609. If Image is selected, then the disc image is output to a file on the local file system, ready to be written to a DVD-R using DVD burning software. If DLT is selected, then the disc image is output to the locally connected DLT tape drive, ready to be sent to the replication facility for mass replication. This disc image may also be saved to a writable DVD media (dvd−r, dvd−rw, dvd+r, dvd+rw) for before mass replication. Status window 614 indicates the presence of errors and describes the status during the process of producing the final image output. The image file location is shown and can be edited in box 610 and the Browse button 612 can be used to set it by browsing through the file system with windows 612A and 612B.

The present invention has many advantages over prior manual and semi-automatic systems. The present invention circumvents the problems that manual authoring systems sometimes encounter when creating long titles such as feature films, which exceed a certain critical running time (or length).

In some prior systems, the editor could not combine files above a critical size (that relates to the running time) so that the title could be played back continuously, due to the limitations of the underlying hardware and software systems. Therefore, the author had to introduce a series of shorter segments with artificial breaks. In many prior systems this had to be done manually.

With the present invention, the author can include chapters or segments and instruct the system, with “one click”, to run them seamlessly together as one continuous playback. To do this the author uses the interface of the editing subsystem to create a play list of the segments to be joined together logically. If this play list totals segments that exceed the critical size it is of no consequence, as on the “click” of the Play button of the Editor subsystem the play list will be used to play back the segments seamlessly as if they are concatenated together. Therefore, system 100 can create titles from input video segments of any running time regardless of the underlying workstation hardware or type.

The present invention may also create interactive links that link content on the web and web to content on the disc. The system may create programmed links in specific chapters of the title that are addressed to specific pages of web content. These links are selected on the finished title just as a chapter is selected. Furthermore, the reverse is also made possible through programmed links in the web content that are addressed to chapters on the disk, and it is this reverse linkage that provides a title made with system 100 a unique synergy between web content and disc content. This two way linking requires the title be produced in a ViDVD format due to the limitations of the DVD-Video. Even files that co-exist on the disc itself can be linked in this way.

To date, there is no system or method that easily creates multimedia titles on disc that can reverse link from the web to the disc other than the present invention. An illustration of the underlying mechanism is shown in FIG. 7. The relationship between disk content and web content shows that text, audio, graphic, video, and other files and content can reside in either the web or the disc. Web content 702 can be accessed from the disc and conversely disc content 720 can be accessed from the web. Web content 702 may comprise video content 702A, audio content 702B, graphics content 702C, and various other content 702D. This content may be stored on any number of servers, and need not necessarily be stored on the same server. The disc content 720 likewise may comprise video content 720A, audio content 720B, graphics content 720C and various other content 720D. This disc content is typically on one disc, but may alternatively reside on multiple discs that may be contemporaneously accessed. The web indexing engine 706 and disc indexing engine 726 receive access requests originated from the web and from the disc respectively and resolve the final content destination and provide quick access to the target content, and also coordinate the timing between the two media. A user 710 accesses the web and disc content through a multimedia device 708 configured to access both web content and disc content, as was previously described.

Web links and universal resource locators are created on the disc with the Editor subsystem, and when the author creates a chapter link to the web site then the address in the form of a Universal Resource Locator is typed in to interface 300 shown in FIG. 3A. The link is added in the same way a chapter is added as previously described with regards to the Editor subsystem shown in FIG. 3. This information is stored in the media database 113 (FIG. 1) when the editing subsystem is instructed by the author to include the link, and later becomes part of the disc image and final disc. FIG. 7 shows storage and access of Web based content and disc based content. The rapid access of the local disc in playing back multimedia content, including large video files, is complimented by the strength of the web in providing dynamic, relevant, and frequently updated information to the user.

In the ViDVD format, the DVD media is used for the storage media, and the content is mainly in DVD-ROM format with optional DVD-Video formatted content co-existing and intermingled on the same disc. When the disc is played in a regular DVD player, only the DVD-Video content is played. No web connectivity is realized, as neither the content nor the player are designed for such connectivity. However, when the disc is played in specially provided software player on a PC, or a specially designed set top player with web connectivity built-in, the two-way connectivity and two-way interactive content is then enabled and may interact with any web site on the Internet. The content on the web site should be in a special format to interact with the DVD based content. The on disc content including the navigational menus is not encoded as video files, but is encoded as HTML based web pages. Therefore, the Web information and the disc information will be in the same well known HTML format, and web information is easily accessed from the disc, just as any universal resource locator (“URL”) is accessed. This is well known in the art. Video and audio resources on disc are accessed via a specially designed URL, which only a specially configured player will understand. As mentioned previously, the specially configured player may be a specially designed piece of hardware, or may simply be a PC with software designed to playback such interactive content. Some platforms that will enable a PC to playback interactive media are WebDVD® from Microsoft® or the Interactual player seen at http://www.interactual.com/. Although these platforms each have their own syntax and formats, they employ similar concepts and may aid in understanding this aspect of the present invention. Interactual's player adds DVD-ROM content and embeds special commands in the control registers to connect to specially designated web content.

A title designed with the present invention that can access web content and that, furthermore, may be accessed from the web, should include links formatted in the following way. References to URL's located on the disc should be formatted to first show the location as being on the disc. The video display location on the screen and its display size also must be included. URLs in this format, when clicked by the user will play the specified MPEG movie file at a designated location on the screen, with a pre-determined size. The user can use the Zoom button on the software player, or the remote control of the set top player, to change the display size.

In order to take a user to another page on the disc, the identifier of the page must be specified. For instance to take the user to a table of contents page, the URL “toc2.htm” would be entered. Web pages are simply specified and accessed in the same fashion according to the standard protocol, such as: http://www.ohanalearning.org.

While embodiments of the present invention have been shown and described, changes and modifications to these illustrative embodiments can be made without departing from the present invention in its broader aspects. Thus, it should be evident that there are other embodiments of this invention which, while not expressly described above, are within the scope of the present invention and therefore that the scope of the invention is not limited merely to the illustrative embodiments presented. Therefore, it will be understood that the appended claims set out the metes and bounds of the invention. However, as words are an imperfect way of describing the scope of the invention, it should also be understood that equivalent structures and methods while not within the express words of the claims are also within the true scope of the invention.

1. A computer storage media comprising instructions for executing a method of creating a DVD-Video, DVD-ROM, ViDVD, or other media, the method comprising:
converting raw input into separate audio and video streams;
indexing the separate audio and video streams;
synchronizing the indexed and separate audio and video streams;
playing the separate and synchronized audio and video streams; and
creating chapters by marking the indexes of the separate and synchronized audio and video streams and thereafter subdividing the separate and synchronized audio and video streams into separate and synchronized audio and video chapter files.

2. The method of claim 1 further comprising:
creating one or more menus comprising button images;
associating the button images with the created chapters such that when the button images are depressed, the chapter will be selected and played in a in a final DVD, ViDVD, or other media.

3. The method of claim 2 further comprising compiling the chapters, button images and other information automatically into one or more video object files.

4. The method of claim 2 further comprising pre-mastering the chapters and menus to form disc image or tape that may then be replicated in mass quantity.

5. The method of claim 2 wherein associating the button images comprises automatically correlating the x-y locations of the buttons on the image with respective actions, such that when a user clicks on or selects one of the x-y locations one of the actions is initiated.

6. The method of claim 1 wherein the synchronizing is automatically performed by a computer program.

7. The method of claim 6 wherein the separate audio and video streams are in a modified MPEG2 format, and wherein a modified MPEG2 player plays back the synchronized and indexed audio and video streams.

8. The method of claim 1 wherein marking the indexes of the separate and synchronized audio and video streams comprises:
selecting a portion of the separate and synchronized audio and video streams;
marking the set in point for the portion; and
marking the set out point for the portion.

9. The method of claim 8 further comprising selecting whether or not to fade in and out the selected portion.

10. A computer system for creating DVD-Video, DVD-ROM, ViDVD or other media configured to:
an editing system operable to index separate audio and video files and synchronize the separate audio and video files using the indexes;
a menu creation system operable to create menus comprising backgrounds and buttons;
a file creation system operable to build an output file from the menus and synchronized audio and video files, the output file in a standard DVD-Video, DVD-ROM, ViDVD or other format.

11. The computer system of claim 10 wherein the editing system is further operable to playback the synchronized audio and video files.

12. The computer system of claim 11 wherein the editing system is further operable to divide the played back synchronized audio and video files into chapter files based upon input from a user.

13. The computer system of claim 10 wherein the editing system is further operable to playback the synchronized audio and video files.

14. The computer system of claim 13 wherein the editing system is further operable to divide the played back synchronized audio and video files into chapter files based upon input from a user.

15. The computer system of claim 10 wherein the editing system is further operable to create links to universal resource locators, and wherein the menu creation system is further operable to create menus containing the links to the universal resource locators such that when a viewer selects the link the system will access content at the universal resource locator.

16. A computer system for creating DVD-Video, DVD-ROM, ViDVD or other media comprising:
an editing system configured to:
index audio and video files;
synchronize the audio and video files using the indexes;
playback the synchronized audio and video files;
divide the played back synchronized audio and video files into chapter files based upon input from a user;
a menu creation system configured to:
create menus comprising background buttons; and
associate the buttons with the playback of the chapters; and
a file creation system configured to:
build an output file from the menus and chapters, the output file in a standard DVD-Video, DVD-ROM, ViDVD or other format.

17. The computer system of claim 16 further comprising a pre-mastering system configured to create a disc or tape image to be used in further replication.

18. The computer system of claim 16 wherein the menus further comprise text and wherein the menu creation system is further configured to alter the font size and color of the text.

19. The computer system of claim 16 wherein the buttons comprise a color having an opacity, and wherein the menu creation system is further configured to alter the color and opacity of the buttons.

20. The computer system of claim 16 wherein the menu creation system is further configured to create a preview of the menus during the menu creation process.

21. The computer system of claim 16 wherein the menu creation system assigns an action to the buttons and the file creation system automatically creates the action when building the output file such that when the button is pressed the action takes place.

22. A system for creating DVD-Video, DVD-ROM, ViDVD or other media comprising:
means for indexing and synchronizing audio and video streams;
means for dividing the audio and video streams into synchronized audio and video segments;
means for creating menus to access the synchronized audio and video segments; and
means for creating a single master file from the menus and synchronized audio and video segments.

23. The system of claim 22 wherein the single master file complies with DVD-Video, DVD-ROM, ViDVD or other media specifications.

24. The system of claim 22 wherein the means for creating a single master file first creates the single master file onto a conventional magnetic storage media.

25. The system of claim 24 wherein the single master file is later transferred to an optical media.

26. A system for making DVDs or other media, the system comprising an interface for creating menus comprising buttons with underlying linking functionality that automatically links the buttons to chapters or other content when clicked upon, the underlying linking functionality automatically created when the buttons are created therefore requiring no additional steps to link the buttons the underlying functionality.

27. The system of claim 26 further comprising an interface wherein a user can define and segment chapters from audio and video content.

28. The system of claim 27 wherein the system creates separate audio and video tracks containing the audio and video content, and wherein the system synchronizes the separate tracks.

29. The system of claim 28 wherein creating the chapters comprises viewing the synchronized audio and video tracks and subdividing the separate audio and video tracks into chapters by clicking on one or more buttons to define a chapter start time and a chapter stop time, each chapter comprising a chapter audio file and chapter video file.

30. The system of claim 29 wherein the system comprises a file server and multiple disks in disk arrays to store the audio tracks, video tracks, the chapter audio files, the chapter video files, and final DVD titles, the disks being partitioned and the disk space allocated for each of the final titles.

31. The system of claim 30 wherein the disk space cannot accommodate additional titles, the system automatically archives titles and erases the space the titles previously occupied to accommodate new titles.

32. The system of claim 26 wherein a user can add subtitles to the audio and video content.
